(19) United States
(12) Patent Application Publication
(10) Pub. No.: US 2012/0124844 A1
(43) Pub. Date: May 24, 2012

(54) Chef's Knife

(76) Inventor: Joachim Droese, Langenfeld (DE)

(21) Appl. No.: 13/303,608

(22) Filed: Nov. 23, 2011

(30) Foreign Application Priority Data
Nov. 24, 2010 (DE) 10 2010 052 363.1

(51) Int. Cl. B26B 3/00

(52) U.S. Cl. 30/314

(57) ABSTRACT

A chef's knife comprises a handle and a blade. The blade has a point, sides, and an edge ground on both of the sides to form a cutting edge. The cutting edge has a section near the handle and a section near the point of the blade. The cutting edge has an acute cutting angle α that becomes continuously smaller from the section near the handle towards the section near the point of the blade.

### CROSS-REFERENCE TO RELATED APPLICATIONS

This application claims priority to German Patent Application No. 10 2010 052 363.1, filed on Nov. 24, 2010, the entire disclosure of which is hereby incorporated herein by reference in its entirety.

### STATEMENT REGARDING FEDERALLY SPONSORED RESEARCH OR DEVELOPMENT

Not Applicable

### FIELD OF THE INVENTION

The invention relates to a chef's knife comprising blade and handle, the edge being ground on both sides to form the cutting edge and forming an acute cutting angle.

### BACKGROUND OF THE INVENTION

Chef's knives are used not only for cutting, but also for chopping. To achieve a perfect dynamic cut (drawing cut) it is necessary that the edge of the blade form the smallest possible cutting angle. A blade honed to such an acute cutting angle is, however, vulnerable during static cutting (chopping) and, thus, will be easily damaged in the edge area.

It would be beneficial to improve a chef's knife so that it always can be used optimally in the various cutting techniques without being damaged.

Thus, a need exists to overcome the problems with the prior art systems, designs, and processes as discussed above.

### SUMMARY OF THE INVENTION

The invention provides a chef's knife that overcomes the hereinafore-mentioned disadvantages of the heretofore-known devices and methods of this general type and that provide such features while being able to be used in the various cutting techniques without being damaged.

With the foregoing and other objects in view, there is provided, in accordance with the invention, a chef's knife comprising a handle and a blade having a point, sides, and an edge ground on both of the sides to form a cutting edge. The cutting edge has a section near the handle and a section near the point of the blade and an acute cutting angle that becomes continuously smaller from the section near the handle towards the section near the point of the blade.

With the objects of the invention in view, there is also provided a chef's knife comprising a handle and a blade having a point, sides, and an edge ground on both of the sides to form a cutting edge. The cutting edge has a section near the handle and a section near the point of the blade and an acute cutting angle that is between 15 and 35 degrees in the section near the handle, is between 10 and 20 degrees in the section near the point of the blade, and defines a largest cutting angle and a smallest cutting angle, and a difference between the largest and smallest cutting angles is at least 8 degrees.

With the objects of the invention in view, there is also provided a chef's knife comprising a handle and a blade having a point, sides, and an edge ground on both of the sides to form a cutting edge. The cutting edge has a section near the handle and a section near the point of the blade, an acute cutting angle that becomes continuously smaller from the section near the handle towards the section near the point of the blade, and a length and a facet, the facet having a width that remains substantially uniform along the length of the edge.

In accordance with another feature of the invention, the cutting angle defines a largest cutting angle and a smallest cutting angle, and a difference between the largest and smallest cutting angles is at least 8 degrees.

In accordance with a further feature of the invention, the cutting angle is between 15 and 35 degrees in the section near the handle and is between 10 and 20 degrees in the section near the point of the blade.

In accordance with an added feature of the invention, the edge has a length and a facet and the facet has a width that remains substantially uniform along the length of the edge.

In accordance with a concomitant feature of the invention, at least in a section near the edge, the blade decreases in thickness from the section near the handle towards the point of the blade.

Advantageously, the invention achieves the improvements by having the cutting angle become continuously smaller from the section near the handle to the point of the blade. Due to such an execution, the edge is of sufficient sharpness in the forward area to achieve perfect cutting results. In the rear section, i.e., further distant from the point of the blade, the edge is, by comparison, far more stable in its execution and is, thus, suitable for chopping without suffering damage.

To this end, the difference between the largest and smallest cutting angles is at least eight degrees. The cutting angle may be between 15 and 35 degrees in the section near the handle and between 10 and 20 degrees in the section near the point.

In an exemplary embodiment, the width of the facet is substantially uniform along the length of the edge. The thickness of the blade, at least in the area near the cutting edge, decreases from the section near the handle to the point of the blade.

Although the invention is illustrated and described herein as embodied in a chef's knife, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a fragmentary, side elevational view of a chef's knife according to the invention with the handle not depicted;

FIG. 2 is a cross-sectional view of the chef's knife of FIG. 1 along section line A-A;

FIG. 3 is an enlarged, cross-sectional view of an edge portion of the chef's knife of FIG. 2;

FIG. 4 is a cross-sectional view of the chef's knife of FIG. 1 along section line B-B; and

FIG. 5 is an enlarged, cross-sectional view of an edge portion of the chef's knife of FIG. 4.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

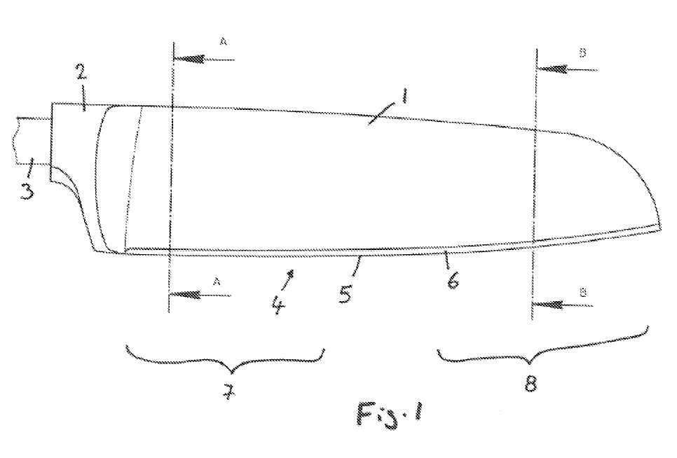

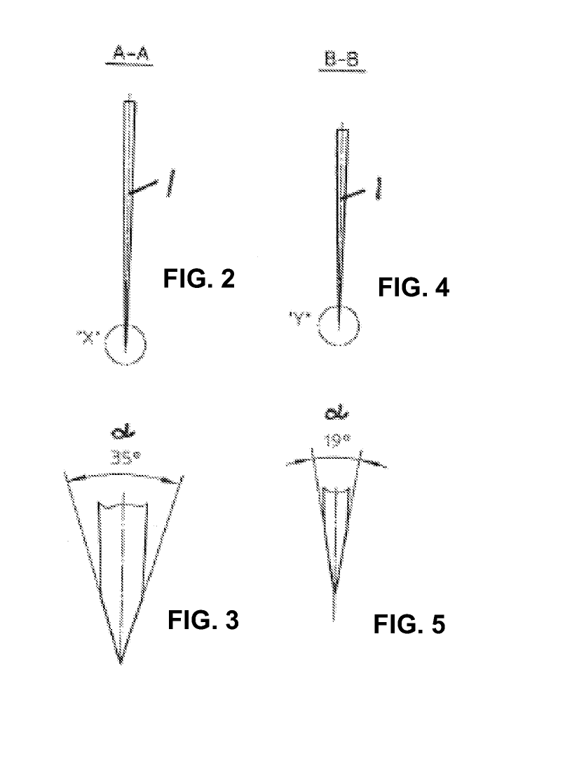

Described now are exemplary embodiments of the present invention. Referring now to the figures of the drawings in detail and first, particularly to FIG. 1, there is shown a first exemplary embodiment of a chef's knife according to the invention. The cutting knife includes a blade 1, a bolster 2 between the handle (not illustrated) and the blade 1, and a tang 3 formed on the bolster 2, which is shown only in part and to which, for example, handle halves are attached on both sides.

The blade 1 has an edge 4 that is ground on both sides to form a cutting edge 5 with a facet 6 is formed on either side of the blade 1.

The edge 4 forms an acute cutting angle α, which becomes continuously smaller from a section 7 near the handle to a section 8 near the point of the blade (far right of the edge 4 in FIG. 1). The difference between the largest and the smallest cutting angle is at least eight degrees (≧8°).

In the section 7 near the handle, the cutting angle is, in an exemplary embodiment, between fifteen degrees (15°) and thirty-five degrees (35°). Thirty-five degrees (35°) is illustrated in FIG. 3. In the section 8 near the point of the blade, the cutting angle is between ten degrees (10°) and twenty degrees (20°), in particular, nineteen degrees (19°), as shown in FIG. 5. The continuous change in the cutting angle is effected such that the width of the facet 6 remains substantially uniform along the length of the edge 4. This feature is also achieved due to the fact that, at least in the area near the edge 4, the blade 1 decreases in thickness from the section 7 near the handle to the point of the blade.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A chef's knife, comprising:
a handle; and
a blade having a point, sides, and an edge ground on both of the sides to form a cutting edge, the cutting edge:
having a section near the handle and a section near the point of the blade; and
having an acute cutting angle that becomes continuously smaller from the section near the handle towards the section near the point of the blade.

2. The chef's knife according to claim 1, wherein the cutting angle defines a largest cutting angle and a smallest cutting angle, and a difference between the largest and smallest cutting angles is at least 8 degrees.

3. The chef's knife according to claim 1, wherein the cutting angle:
is between 15 and 35 degrees in the section near the handle; and
is between 10 and 20 degrees in the section near the point of the blade.

4. The chef's knife according to claim 2, wherein the cutting angle:
is between 15 and 35 degrees in the section near the handle; and
is between 10 and 20 degrees in the section near the point of the blade.

5. The chef's knife according to claim 1, wherein:
the edge has a length and a facet; and
the facet has a width that remains substantially uniform along the length of the edge.

6. The chef's knife according to claim 1, wherein, at least in a section near the edge, the blade decreases in thickness from the section near the handle towards the point of the blade.

7. A chef's knife, comprising:
a handle; and
a blade having a point, sides, and an edge ground on both of the sides to form a cutting edge, the cutting edge:
having a section near the handle and a section near the point of the blade; and
having an acute cutting angle that:
is between 15 and 35 degrees in the section near the handle;
is between 10 and 20 degrees in the section near the point of the blade; and
defines a largest cutting angle and a smallest cutting angle, and a difference between the largest and smallest cutting angles is at least 8 degrees.

8. The chef's knife according to claim 7, wherein the cutting angle becomes smaller from the section near the handle towards the section near the point of the blade.

9. The chef's knife according to claim 8, wherein the cutting angle becomes continuously smaller from the section near the handle towards the section near the point of the blade.

10. The chef's knife according to claim 7, wherein:
the edge has a length and a facet; and
the facet has a width that remains substantially uniform along the length of the edge.

11. The chef's knife according to claim 7, wherein, at least in a section near the edge, the blade decreases in thickness from the section near the handle towards the point of the blade.

12. A chef's knife, comprising:
a handle; and
a blade having a point, sides, and an edge ground on both of the sides to form a cutting edge, the cutting edge having:
a section near the handle and a section near the point of the blade;
an acute cutting angle that becomes continuously smaller from the section near the handle towards the section near the point of the blade; and
a length and a facet, the facet having a width that remains substantially uniform along the length of the edge.

13. The chef's knife according to claim 12, wherein the cutting angle defines a largest cutting angle and a smallest cutting angle, and a difference between the largest and smallest cutting angles is at least 8 degrees.

14. The chef's knife according to claim 12, wherein the cutting angle:
is between 15 and 35 degrees in the section near the handle; and
is between 10 and 20 degrees in the section near the point of the blade.

15. The chef's knife according to claim 13, wherein the cutting angle:
is between 15 and 35 degrees in the section near the handle; and
is between 10 and 20 degrees in the section near the point of the blade.

16. The chef's knife according to claim 12, wherein, at least in a section near the edge, the blade decreases in thickness from the section near the handle towards the point of the blade.
